(19) United States
(12) Patent Application Publication
(10) Pub. No.: US 2006/0127688 A1
(43) Pub. Date: Jun. 15, 2006

(54) Transparent biaxially oriented polyolefin film having an improved oxygen barrier

(75) Inventors: Detlef Busch, Saarlouis (DE); Joachim Jung, Neunkirchen (DE)

Correspondence Address: CONNOLLY BOVE LODGE & HUTZ, LLP, P O BOX 2207, WILMINGTON, DE, 19899, US

(73) Assignee: Treofan Germany GmbH Co. KG, Neunkirchen (DE)

(21) Appl. No.: 10/535,577

(22) PCT Filed: Nov. 20, 2003
(86) PCT No.: PCT/EP03/12974

§ 371 Date: Jan. 19, 2006

(30) Foreign Application Priority Data
Nov. 23, 2002 (DE) 102 54 731.9

(51) Int. Cl. B32B 27/08; B32B 19/00

(52) U.S. Cl. 428/500; 428/516; 428/910; 428/702; 427/402

(57) ABSTRACT

The invention relates to a coated, coextruded, biaxially stretched polyolefin film, which contains at least one base layer B made of polyolefins and a top layer Z made of polyolefins modified using maleic acid anhydride, characterized in that a coating made of a primer, which forms the primer layer P, is applied to the surface of the top layer Z, and an inorganic coating made of lithium-potassium polysilicates, which forms a polysilicate layer, is applied to the surface of the primer layer P.

The present invention relates to a transparent polyolef in film having an improved oxygen barrier, as well as its use, particularly for manufacturing laminates.

Methods for improving barrier properties of polyolefin films, particularly polypropylene films, are known in the related art. Polypropylene films as such already have a good water vapor barrier. The oxygen barrier is in need of improvement. Various coating systems have been developed in the past to improve the oxygen barrier. For example, providing polypropylene films with coatings made of PVDC or PVOH is known. Through this measure, the oxygen barrier may be lowered using PVDC coating from approximately 2000 cm³/m²*day*bar to approximately 20 cm³/m²*day*bar and using PVOH coatings to approximately 3 cm³/m²*day*bar. However, it has been shown that these barrier values of PVOH-coated films are sensitive to ambient humidity.

In addition to these coatings, in recent times coating systems have been developed which may be applied from aqueous solutions and which are based on polysilicates. This technology is described, for example, in PCT application 97/47678. These systems are subject to the disadvantage that the barrier values are subject to strong variations. The ambient humidity also has a—sometimes undesired negative—influence on the oxygen barrier here. These disadvantages may be partially remedied by an additional primer layer. The primer layer is applied to the pretreated polypropylene film. Subsequently, the primed film is coated with the aqueous polysilicate solution. This refinement is described in U.S. Pat. No. 6,368,677. It has been found that these film structures have a further improved oxygen barrier, which is still not sufficient for all applications, however. Furthermore, the bond adhesion in the further processing of the silicate-coated films into laminates and composites is unsatisfactory.

A further embodiment of polysilicate-coated films, in which the polysilicate layer is applied to a top layer modified using maleic acid anhydride, is described in PCT application having publication number WO 00/09596. According to this teaching, the polysilicate layer not only has good adhesion on the modified surface, but it has also been shown that the barrier values are improved by this measure.

The object of the present invention is therefore to provide a polyolefin film which is distinguished by an especially good oxygen barrier, this oxygen barrier having to be maintained both at low ambient humidity and at high ambient humidity. Furthermore, it is important that the film be suitable for manufacturing laminates, i.e., that this laminate must have a good bond adhesion, particularly even after sealing. The remaining required usage properties of the film may not be impaired in this case.

This object is achieved by a transparent polyolefin film which comprises at least four layers BZPS, the layer B being a base layer made of polyolefin and the layer Z being a layer made of polyolefins modified using maleic acid anhydride and the layer P being a primer layer which is applied to a surface of the layer Z and the layer S being an inorganic coating made of lithium-potassium polysilicates which is applied from an aqueous solution of lithium-potassium polysilicates. The subclaims specify preferred embodiments of the present invention.

It has been found that through the combination of the modified layer Z with a primer in the layer construction of the film, the barrier properties of the films according to the present invention may be significantly improved. In particular, the oxygen barrier is elevated further in relation to analogous layer constructions without primers. The oxygen barrier of the film according to the present invention also shows significantly fewer variations, particularly during the processing of the film into the composite or in the event of other mechanical strains or in the event of oscillating ambient humidity. The film according to the present invention displays significantly better barrier properties than basic films which have a typical non-modified polyolefinic intermediate layer and a primer. Apparently a synergistic effect arises through the combination of the layer modified using maleic acid anhydride and the primer layer, which has an especially advantageous effect on the oxygen barrier of the polysilicate layer and its resistance in the event of different loads.

The layer Z of the film construction according to the present invention may be viewed as an intermediate layer of the overall film construction (film having silicate coating). It is simultaneously the top layer of the coextruded basic film made of base layer, layer Z, and possibly further layers (film without primer and silicate coating). In general, this intermediate layer Z is applied directly to the base layer B of the film. However, other embodiments which have further layers between the base layer B and the layer Z are also conceivable. In general, the base layer B and intermediate layer Z are coextruded, possibly together with further layers. The intermediate layer Z thus forms an external top layer of the coextruded basic film, which is subsequently coated using primer and polysilicate coating. In a preferred embodiment, this basic film may have a second top layer, preferably a sealable second top layer, on the diametrically opposing side.

The layer Z generally contains at least 50 weight-percent, preferably 70 to 100 weight-percent, particularly 80 to <100 weight-percent, each in relation to the intermediate layer, of a polyolefin modified using maleic acid anhydride. In addition to this modified polyolefin, further components of the intermediate layer may be non-modified polyolefinic polymers, which are synthesized only from ethylene, propylene, or butylene units. These additional polyolefins are contained in a quantity of 0 to 30 weight-percent, particularly >0 to 20 weight-percent, in relation to the intermediate layer in each case. The intermediate layer possibly contains additional typical additives in the particular effective quantities.

Polyolefins modified using maleic acid anhydride are polyolefins which are hydrophilized by the incorporation of maleic acid units. Greatly varying propylene polymers or ethylene polymers may be used as the base polyolefins, with polyethylenes, propylene homopolymers, propylene copolymers, and propylene terpolymers being preferred as the base polymer. Polypropylenes modified using maleic acid anhydride are especially preferred. The base polymers are grafted with maleic acid anhydride to manufacture the modified polypropylene. The corresponding manufacturing methods are described, for example, in U.S. Pat. No. 3,433,777 and U.S. Pat. No. 4,198,327, to which reference is expressly made here. The density according to ASTM D 1505 of the modified polyolefins is preferably in a range from 0.89 to 0.92 g/cm³, particularly 0.9 g/cm³, the Vicat softening point according to ASTM 1525 is in a range from 120 to 150° C., particularly 140 to 145° C., the Shore hardness according to ASTM 2240 is 55 to 70, preferably 67° C., and the melting point according to ASTM D 2117 is in a range from 150 to 165° C., preferably 155 to 160° C. The maleic acid component in the modified polyolefin is generally below 5 weight-percent in relation to the modified polyolefin, preferably in the range from 0.05 to 3 weight-percent, particularly 0.1 to 1 weight-percent. The melt-flow index is generally 1 to 30 g/10 minutes, preferably 3 to 20 g/10 minutes. Polypropylenes modified using maleic acid anhydride of this type are known in the related art and are commercially available and are sold, for example, under the trade names Polybond and Priex.

In the following, the polyolefins which are used as the base polymer for the modification using maleic acid anhydride are described in greater detail. These polymers are also suitable as further components (as non-modified olefinic polymers) in the intermediate layer Z for admixing with the modified polyolefins.

Polyolefins are, for example, polyethylenes, polypropylenes, polybutylenes, or mixed polymers made of olefins having two to eight C atoms, of which polyethylenes and polypropylenes are preferred.

In general, the propylene polymer contains at least 90 weight-percent, preferably 94 to 100 weight-percent, particularly 98 to 100 weight-percent propylene. The corresponding comonomer content of at most 10 weight-percent or 0 to 6 weight-percent or 0 to 2 weight-percent, respectively, generally comprises, if present, ethylene and butylene. The specifications in weight-percent each relate to the propylene homopolymers.

Isotactic propylene homopolymers having a melting point of 140 to 170° C., preferably 155 to 165° C., and a melt-flow index (measurement DIN 53 735 at 21.6 N load and 230° C.) of 1.0 to 10 g/10 minutes, preferably 1.5 to 6.5 g/10 minutes, may possibly be used. The n-heptane-soluble component of the isotactic propylene homopolymers is generally 1 to 10 weight-percent, preferably 2-5 weight-percent in relation to the starting polymers.

Polyolefins may also be copolymers or terpolymers, preferably copolymers of ethylene and propylene or ethylene and butylene or propylene and butylene or terpolymers of ethylene and propylene and butylene or mixtures made of two or more of the copolymers and terpolymers cited. Of these, mixed polymers, which are synthesized predominantly, >70 weight-percent, for example, from propylene units are preferred.

In particular, random ethylene-propylene copolymers having an ethylene content of 1 to 10 weight-percent or random propylene-butylene-1 copolymers having a butylene content of 2 to 25 weight-percent, each in relation to the total weight of the copolymers, or random ethylene-propylene-butylene-1 terpolymers having an ethylene content of 1 to 10 weight-percent and a butylene-1 content of 2 to 20 weight-percent, each in relation to the total weight of the terpolymer, or a blend made of ethylene-propylene-butylene-1 terpolymers and propylene-butylene-1 copolymers, the blend having an ethylene content of 0.1 to 7 weight-percent, a propylene content of 50 to 90 weight-percent, and a butylene-1 content of 10 to 40 weight-percent, each in relation to the total weight of the polymer blend, are preferred.

The copolymers and terpolymers described above generally have a melt-flow index of 1.5 to 30 g/10 minutes, preferably 3 to 15 g/10 minutes. The melting point is in the range from 120 to 140° C. The blend made of copolymers and terpolymers described above has a melt-flow index of 5 to 9g/10 minutes and a melting point of 120 to 150° C. All melt-flow indices specified above were measured at 230° C. and a force of 21.6 N (DIN 53 735).

The molecular weight distribution of the polyolefins described above may very in wide limits depending on the field of application. The ratio of the weight average M_{w} to the number average Mₙ is generally between 1 and 15, preferably in the range from 2 to 10. A molecular weight distribution of this type is achieved, for example, through peroxidic degradation or by manufacturing the polyolefin using suitable metallocene catalysts.

The intermediate layer may possibly contain additional typical additives, preferably antiblocking agents, neutralization agents, and stabilizers, each in effective quantities.

The thickness of the intermediate layer made of modified polyolefin is generally greater than 0.1 μm and is preferably in the range from 0.3 to 3 μm, particularly 0.4 to 1.5 μm.

The base layer B of the polyolefin film is synthesized in principle from the polyolefins described above, of which the propylene homopolymers described above are preferred, particularly isotactic propylene homopolymers. In general, the base layer contains at least 70 to 100 weight-percent, preferably 80 to <100 weight-percent polyolefin and/or propylene polymer. Furthermore, neutralization agents and stabilizers, and possibly further typical additives each in effective quantities, are typically also contained in the base layer. For opaque or white-opaque embodiments of the film, the base layer additionally contains vacuole-initiating fillers and/or pigments. The type and quantity of the fillers are known in the related art.

After manufacturing of the coextruded basic film, the adhesion promoter or primer is applied to the intermediate layer described above. Suitable primers are based on random vinyl polymers which are derived from “vinyl” monomers such as vinyl alcohol, vinyl acetate, vinyl phenol, etc. Suitable primers, as well as the composition of the primer solutions and also the method for applying the primer are described in detail in PCT/US97/10073 (publication number WO 97/47678, page 3, line 24 through page 8, line 16). Reference is hereby expressly made to this publication.

In the scope of the present invention, polyvinyl alcohols (PVOH) are especially preferred as the primer. PVOH primers are known per se in the related art and are commercially available. PVOH has been used for some time for improving the printability of oriented polypropylene films. PVOH is manufactured through polymerization of vinyl acetates and subsequent hydrolysis of the acetate functions, certain proportions of acetate functions still being retained depending on the degree of hydrolysis. The degree of hydrolysis is generally at least 80%, preferably 85 to <100%.

To apply the primer, PVOH is dissolved in suitable solvents, such as water or alcohols, such as propanols, ethanol, methyl alcohol, or mixtures thereof, the PVOH content generally being between 0.1 to 15 weight-percent, preferably 2 to 10 weight-percent, in relation to the weight of the solution. From the solution, the primer is applied to the surface of the modified intermediate layer z using coating methods known per se and subsequently dried. The PVOH layer is not cross-linked.

In general, it is advantageous to subject the surface of intermediate layer Z to a surface treatment using suitable methods for the purpose of elevating the surface tension before applying the primer. A corona or flame treatment is suitable, for example, plasma methods also being able to be used for the pretreatment if necessary.

After the application of the primer layer, the film is provided with a polysilicate coating in a way known per se. Methods for applying the polysilicate from aqueous solution, as well as the composition of the solution and further details, are described, for example, in PCT 97/44379, EP 0 900 250, EP 0 906 373, and PCT 97/47694, to which reference is expressly made here.

The polysilicate coating is applied to the film side having the primer layer (i.e., to the surface of the primer layer), the application being performed from an aqueous polysilicate solution. For the purposes of the present invention, aqueous solutions containing alkali metal polysilicates, such as lithium and potassium copolysilicate, are especially suitable. The coating solution preferably contains a copolysilicate, i.e., a mixture made of two different alkali metal polysilicates, such as a mixture of lithium and potassium copolysilicates of the general formula (Li₂O)ₓ(K₂O)₁₋ₓ(SiO₂)_{y}, in which x is the mole fraction of Li₂O and y is the mole ratio SiO₂:M₂O (M₂O stands for the sum of Li₂O and K₂O). In the copolysilicates, the value for x is between 0 and 1 and may vary within this range. Copolysilicates which have approximately equimolar quantities of Li₂O and K₂O or a higher quantity of Li₂O, i.e., copolysilicates having an x value of 0.4 to <1 are especially preferred, with a preferred x value of approximately 0.5 to 0.7. The SiO₂ proportion of these copolysilicates is fixed via the y values and is generally 1 to 10, preferably 4.6 to 10. Therefore, copolysilicates of the above formula which simultaneously fulfill 0<x<1, preferably 0.4<x<0.7, and y=1 to 10, preferably 4.6 to 10, are preferred.

The polysilicate solutions may additionally contain a suitable surfactant to reduce the surface tension, non-ionic surfactants, particularly acetylene glycols and alkyl ethoxylates, being preferred. The quantity of surfactant may be tailored depending on the surfactant used and is preferably below 1 weight-percent, preferably in the range from 0.01 to 0.5 weight-percent, in relation to the aqueous solution.

The polysilicate solution used for the coating is preferably colorless or transparent and may be manufactured from commercially available lithium polysilicate and potassium polysilicate solutions. For example, a commercially available colloidal suspension of lithium polysilicate may be mixed with a commercially available colloidal suspension of potassium polysilicate to manufacture coating solutions according to the present invention. For example, an aqueous, colloidal suspension of lithium polysilicate containing approximately 25 weight-percent silicon dioxide and approximately 3.0 weight-percent lithium oxide is suitable. A second commercially available aqueous colloidal suspension contains approximately 26.8 weight-percent silicon dioxide and approximately 13 weight-percent potassium oxide. These products are then mixed with water until reaching the desired solid content.

The mole ratio SiO₂:M₂O of the dried coatings identified using y may be set through the mole ratios SiO₂:Li₂O and SiO₂:K₂O of the starting solutions. Variation of the mole ratio is also possible, for example, by adding colloidal silicon dioxide to the aqueous coating solution. The solid content of the coating solutions is generally up to 25 weight-percent, preferably 1 to 20 weight-percent, and is a function of the coating method used and the desired layer thickness of the polysilicate coating after drying. The layer thickness after drying is, for example, to be between 100 and 500 nm, preferably 200-300 nm. Setting the layer thickness is possible without anything further according to the current related art [see, for example, Canadian Patent Number 993,738].

The coating solutions are stirred and possibly filtered after the different components are combined. In this phase, a surfactant may be added if necessary to reduce the surface tension of the coating solution. For example, commercially available Genapol® 26-L-60N, a non-ionic surfactant from Hoechst Celanese, or other surfactants such as Genapol® UD050 (Hoechst) and Dynol 604® come into consideration. The solution is then applied to the film surface using suitable methods.

Suitable coating methods are, for example, roller application, spray coating, and immersion coating. For roller application, among other things, doctor blade coating, reversing roll coating, direct roll coating, coating using the air knife coater, knife-over-roll coater, and blade coater, gravure coating, and coating using a sheet die come into consideration. General descriptions of these coating methods are found in the literature, for example, in Modern Coating and Drying Techniques (eds. E. Cohen and E. Gutoff; VCH Publishers, New York 1992) and Web Processing and Converting Technology and Equipment (ed. D. Satas, Van Nostrand Reinhold, New York 1984). The present invention is not restricted to specific coating methods of the polysilicate coating. The particular methods may be selected among those cited and other methods known to those skilled in the art.

After the coating with the aqueous polysilicate solution, the coated film must be dried at a selected temperature (room temperature or higher temperature). The selection of this temperature is a function of the desired drying time. Shorter drying times may be achieved using high temperatures, which may be dispensed with if a longer drying time comes into consideration. Suitable temperatures may be in the range from 25 to 200° C., preferably 40 to 150° C., and particularly in the range from 70 to 120° C.

The total thickness of the film construction according to the present invention, i.e., including the primer and silicon coating, may vary within wide limits and depends on the intended use. It is preferably 4 to 100 μm, particularly 5 to 80 μm, preferably 10 to 50 μm, the base layer making up approximately 40 to 100% of the total film thickness.

In a further especially advantageous embodiment, the polyolefin film is used to manufacture a laminate. In this case, it is essential to the present invention that the polysilicate-coated side of the film be laminated against a further film. The lamination may also be performed using extrusion lamination, however, and lamination against a further film with the aid of laminating adhesives is especially advantageous. Lamination against a polyethylene film has particularly proven itself in this case. In principle, the typical PE laminating films are suitable as the polyethylene film. For example, commercially available solvent-free laminating adhesives are suitable.

The film according to the present invention is distinguished by an outstanding oxygen barrier, which is additionally very stable to greatly varying loads. In the scope of the present invention, it has been found that starting from silicon-coated films which are known per se, the oxygen barrier may still be decisively improved by the selected substrate to be coated. For this purpose, not only the basic film itself, but rather also the selected primer is important, however. The present invention is therefore based on a synergistic effect of three components, the silicon coating, the primer, and the modified basic film.

Furthermore, the present invention relates to a method for manufacturing the film construction according to the present invention. In the course of this method, firstly the biaxially oriented basic film is separately manufactured using coextrusion and subsequent biaxial stretching. This basic film comprises at least the base layer and intermediate layer described above and generally a further layer on the diametrically opposite side of the base layer, as well as possible further layers, so that three-layered, four-layered, and five-layered film constructions of the basic film result. It is essential that the intermediate layer described above forms an external top layer of the basic film.

The basic film is manufactured through coextrusion, preferably according to the stentering method. In the course of this method, the melts corresponding to the individual layers of the film are coextruded through a sheet die, the film thus obtained is drawn off on one or more roll(s) for solidification, the film is subsequently stretched (oriented), and the stretched film is thermofixed and possibly corona or flame treated on the surface layer provided for treatment.

Biaxial stretching (orientation) is performed sequentially or simultaneously. Sequential stretching is generally performed in sequence, sequential biaxial stretching, in which stretching is first performed longitudinally (in the machine direction) and then transversely (perpendicularly to the machine direction) being preferred. Simultaneous stretching may be performed in the flat film method or in the blowing method. The film manufacturing will be described further on the basis of the example of flat film extrusion with subsequent sequential stretching.

During the extrusion, the polymers or the polymer mixture of the individual layers are compressed in an extruder and liquefied, the additives possibly added already able to be contained in the polymer and/or in the polymer mixture. The melts are then pressed simultaneously through a sheet die, and the multilayer film pressed out is drawn off on one or more draw-off rolls, so that it cools and solidifies. The temperature of the draw-off rolls is generally in a range from 10 to 100° C., preferably 20 to 50° C.

The precursor film thus obtained is then stretched longitudinally and transversely to the extrusion direction, which results in orientation of the molecular chains. The longitudinal stretching is expediently performed with the aid of two rolls running at different speeds corresponding to the stretching ratio desired and the transverse stretching is performed with the aid of a corresponding tenter frame. The longitudinal stretching ratios lie in the range of 4 to 8, preferably 5 to 6. The transverse stretching ratios lie in the range from 5 to 10, preferably 7 to 9.

The temperatures at which longitudinal and transverse stretching are performed may vary in a relatively large range and are a function of the desired properties of the film. In general, the longitudinal stretching is performed at 80 to 130° C. and the transverse stretching is preferably performed at 120 to 170° C.

The stretching of the film is followed by its thermofixing (heat treatment), the film being held approximately 0.1 to 10 seconds long at a temperature of 100 to 160° C. The film is subsequently wound up in a typical way using a winding device.

Preferably, one or both surfaces of the film is/are corona or flame treated according to one of the known methods after the biaxial stretching. The treatment intensity is generally in the range from 37 to 50 mN/m, preferably 39 to 45 mN/m.

The PVOH primer is applied to the surface of the modified top layer Z according to methods known per se. Basically, the identical known methods are used for the subsequent coating with the polysilicate. Known methods of this type are, for example, roll application methods, particularly reverse gravure methods, spraying methods, and immersion methods. A general description of the different usable coating methods is found in Modern Coating and Drying Techniques (E. Cohen and E. Gutoff eds., VCH Publishers, New York, 1992).

The present invention will now be explained in greater detail through exemplary embodiments:

Manufacturing of the basic film

### EXAMPLE 1

A transparent, three-layered film having the construction A/B/Z and a total thickness of 30 μm was manufactured through coextrusion and subsequent step-by-step orientation in the longitudinal and transverse directions. The top layer A had thickness of 0.7 μm, the thickness of the layer Z was 0.7 μm. The film was pretreated on the surface of the layer Z using corona.

Base layer (B):

approx. 100 weight-percent isotactic propylene homopolymer having a melting point of 166° C. and a melt-flow index of 3.3 g/10 minutes
   Top layer: Z
approx. 100 weight-percent isotactic propylene homopolymer grafted with maleic acid anhydride having a melting point of 157° C. and a melt flow index of 7 g/10 minutes
   Top layer: A
approx. 100 weight-percent propylene terpolymer (C2C3C4) having a melting point of 133° C. and a melt-flow index of 6 g/10 minutes and an ethylene content of approximately 2 weight-percent and a butylene content of approximately 9 weight-percent.

All layers contained stabilizers and neutralization agents in typical quantities. The manufacturing conditions in the individual method steps were:

Extrusion:

Temperatures base layer B: 260° C. layer A: 255° C. layer Z: 250° C. temperature of the draw-off roll: 20° C.
Longitudinal stretching: temperature: 105° C. longitudinal stretching ratio: 4.5
Transverse stretching: temperature: 170° C. transverse stretching ratio: 8
Fixing: temperature: 145° C.
Convergence: 2%

Immediately after its manufacture, the biaxially oriented film has a surface tension of 42 mN/m on the pretreated surface of the layer Z. The film is transparent and has an oxygen barrier of approximately 1800 cm³/m²*day*bar at 23° C. and 50% relative humidity.

### EXAMPLE 2 (COMPARATIVE EXAMPLE)

A film was manufactured as described in example 1, the layer Z being synthesized from a typical propylene-ethylene copolymer, in contrast to example 1. The composition of the remaining layers and the method conditions from Example 1 were not changed.

Layer Z:

approx. 100 weight-percent propylene-ethylene copolymer (C2C3) having a melting point of 135° C. and a melt-flow index of 6 g/10 minutes and an ethylene content of approximately 4 weight-percent

The surface tension of this film was 40 mN/m on the pretreated Z side. The film is transparent and has an oxygen barrier of approximately 1800 cm³/m²*day*bar at 23° C. and 50% relative humidity.

Manufacturing of the Coated Films

The basic films according to the example and the comparative example were provided on the surface of the particular top layer Z with a PVOH primer and subsequently coated with an aqueous silicate solution according to the present invention. As a comparison thereto, the aqueous solution was applied directly, i.e., without primer, to the particular top layer Z of the different basic films.

### EXAMPLE 3 (COMPARATIVE EXAMPLE)

The film having modified top layer Z according to Example 1 was coated on the pretreated surface of the modified top layer Z with PVOH.

### EXAMPLE 4 (COMPARATIVE EXAMPLE)

The film having copolymer top layer Z according to Example 2 was coated with PVOH.

### EXAMPLE 5 (COMPARATIVE EXAMPLE)

The film having modified top layer z according to Example 1 was coated directly (without PVOH primer) on the pretreated surface of layer Z with an aqueous polysilicate solution.

### EXAMPLE 6 (COMPARATIVE EXAMPLE)

The film having copolymer top layer according to Example 2 was coated directly (without PVOH primer) on the pretreated surface of layer Z with an aqueous polysilicate solution.

### EXAMPLE 7 (EXAMPLE ACCORDING TO THE PRESENT INVENTION)

The film having modified top layer and PVOH primer according to Example 3 was coated on the primed surface with a polysilicate solution.

### EXAMPLE 8 (comparative example)

The film having copolymer top layer and PVOH primer according to Example 4 was coated on the primed surface with a polysilicate solution.

The coated films according to Example 5 to 8 were additionally laminated using a laminating adhesive with a polyethylene film having a thickness of 50 μm. The lamination was performed against the polysilicate coating. In addition, the barrier properties of the laminated films were assayed.

TABLE 1

| | MAH- | | Application | | Application | O₂ | O₂ | |
|---|---|---|---|---|---|---|---|---|
| | modified | | weight primer | Polysilicate | weight | barrier | barrier | |
| Example | layer | Primer | g/m² dry | coating | polysilic | [cm³/m²*d | after PE | |
| B 1 | Yes | — | 0 | — | 0 | 1800 | — | Basic film |
| VB 2 | — | — | 0 | — | 0 | 1800 | — | Basic film with |
| VB 3 | Yes | PVOH | approx. 0.4 | — | 0 | 1.83 | 0.76 | Basic film |
| VB 4 | — | PVOH | approx. 0.4 | — | 0 | >200 | >200 | Basic film with |
| VB 5 | Yes | — | 0 | Yes | approx. 0.8 | 4.72 | 12.4 | Basic film |
| VB 6 | — | — | 0 | Yes | approx. 0.8 | >200 | 35 | Basic film with |
| B 7 | Yes | PVOH | approx. 0.4 | Yes | approx. | <1 | 0.5 | Basic |
| VB 8 | — | PVOH | approx. 0.4 | Yes | approx. | 6.41 | 1.46 | Basic |

VB comparative example, not an embodiment according to the present invention

The following measurement methods were used to characterize the raw materials and the films:

Melt-flow Index

The melt-flow index was measured according to DIN 53735 at 21.6 N load and 230° C.

Melting Point

DSC measurement, maximum of the melting curve, heating speed 20° C./minute.

Bond Adhesion

The bond strength was measured on composites in the sealed and unsealed state. The sealing conditions used in this case were contact time t=0.5 s, seal temperature θ=150° C. and seal pressure p=13.8 N/cm². The bond adhesion was measured on 15 mm wide strips and is specified in N15 mm.

Oxygen Barrier

The oxygen permeability was measured according to the oxygen-specific carrier gas method, DIN 53380-3 and/or ASTM D 3985, at 23° C. and 50% relative humidity.

1. A coated, coextruded, biaxially stretched polyolefin film, which comprises at least one base layer B made of polyolefins and a top layer Z made of polyolefins modified using maleic acid anhydride,
characterized in that a coating made of a primer, which forms the primer layer P, is applied to the surface of the top layer Z, and an inorganic coating made of lithium-potassium polysilicates, which forms a polysilicate layer, is applied to the surface of the primer layer P.

2. The polyolefin film according to claim 1, characterized in that the coextruded and biaxially stretched basic film has a further top layer on the side diametrically opposite the layer Z.

3. The polyolefin film according to claim 1, characterized in that the polysilicate coating is applied from an aqueous solution of lithium and potassium polysilicates.

4. The polyolefin film according to claim 1, characterized in that the polysilicate coating is a mixture of lithium and potassium polysilicates of the general formula (Li₂O)ₓ(K₂O)₁₋ₓ(SiO₂)_{y}, in which x is the mole fraction of Li₂O and y is the mole ratio SiO₂:K₂O and x=0.4 to<1 and y=1 −10.

5. The polyolefin film according to claim 1, characterized in that the primer layer is a layer made of PVOH.

6. The polyolefin film according to claim 5, characterized in that the PVOH has a degree of hydrolysis of 85 to <100%.

7. The polyolefin film according to claim 1, characterized in that the layer Z contains 80 to 100 weight-percent of a polypropylene homopolymer, propylene copolymer, or polyethylene grafted using maleic acid anhydride.

8. The polyolefin film according to claim 1, characterized in that the polypropylene homopolymer, propylene copolymer, or polyethylene grafted using maleic acid anhydride has a maleic acid anhydride content of 0.05 to 3 weight-percent in relation to the weight of the polymer.

9. The polyolefin film according to claim 1, characterized in that the polypropylene homopolymer, propylene copolymer, or polyethylene grafted using maleic acid anhydride has a melting point of 150 to 165° C. and a Vicat softening point of 120 to 150° C.

10. The polyolefin film according to claim 1, characterized in that the layer Z additionally contains >0 to 30 weight-percent non-modified olefinic polymers made of propylene, ethylene, or butene units,

11. The polyolefin film according to claim 1, characterized in that the basic film has a further top layer made of sealable polyolefinic polymers on the diametrically opposite surface of the base layer.

12. The polyolefin film according to claim 1, characterized in that the layer Z has a layer thickness of 0.3 to 3 μm.

13. The polyolefin film according to claim 1, characterized in that first a basic film, which comprises at least the base layer B and the layer Z, is manufactured according to the coextrusion method, and subsequently the surface of layer Z is coated with PVOH and subsequently a polysilicate coating is applied to the PVOH coating.

14. The polyolefin film according to claim 1, characterized in that the coextruded basic film has further coextruded layers and the basic film is a three-layered, four-layered, or five-layered basic film and the further layers are synthesized from polyolefins.

15. The polyolefin film according to claim 1, characterized in that the coextruded basic film is a three-layered film having a sealable top layer on the diametrically opposite side of the base layer, which is synthesized from propylene copolymers or propylene terpolymers.

16. The polyolefin film according to claims 1, characterized in that the polyolefin film has an oxygen permeability at 23° C. and 50% relative humidity of less than 1 cm³/m²*day*bar.

17. A laminate made of a coated polyolefin film according to claim 1, characterized in that the polyolefin film is laminated into a laminate with a polyethylene film using laminating adhesive, the lamination being performed against the polysilicate-coated side.

18. The laminate according to claim 17, characterized in that the laminate has an oxygen permeability at 23° C. and 50% relative humidity of less than 0.5 cm³/m²*day*bar.

19. The laminate according to claim 17, characterized in that a solvent-free laminating adhesive is used for the lamination.

20. A method for manufacturing a coated film, characterized in that a coextruded, biaxially stretched film is manufactured which has a base layer B and a first top layer Z and a second top layer made of sealable polyolefins, the layer Z being synthesized from polyolefin grafted with maleic acid anhydride and the surface of the layer Z being provided with a PVOH coating and a polysilicate coating being applied from aqueous solution onto the surface of the PVOH coating.

21. The polyolefin film according to claim 9, characterized in that the layer Z additionally contains>0 to 30 weight-percent non-modified olefinic polymers made of polyethylene, polypropylene, propylene terpolymers, and propylene copolymers.
